(19) United States
(12) Patent Application Publication
(10) Pub. No.: US 2025/0101246 A1
(43) Pub. Date: Mar. 27, 2025

(54) INKJET BINDER COMPOSITION

(71) Applicant: Hewlett-Packard Development Company, L.P., Spring, TX (US)

(72) Inventors: Kyle Wycoff, Palo Alto, CA (US); Michelle M. Niu, Palo Alto, CA (US); Krzysztof Nauka, Palo Alto, CA (US)

(21) Appl. No.: 18/832,885

(22) PCT Filed: Feb. 1, 2022
(86) PCT No.: PCT/US2022/014766

§ 371 Date: Jul. 24, 2024

(51) Int. Cl. C09D 11/38; B22F 1/102; B22F 10/14; B33Y 70/10; C09D 11/033; C09D 11/037; C09D 11/101; C09D 11/107; C09D 11/322

(52) U.S. Cl. CPC C09D 11/38; B22F 1/102; B33Y 70/10; C09D 11/033; C09D 11/037; C09D 11/101; C09D 11/107; C09D 11/322; B22F 10/14

(57) ABSTRACT

An inkjet binder composition includes a vehicle, which includes water and an ether co-solvent. The binder composition also includes a free radical photoinitiator and less than 30 wt % active, based on a total weight of the binder composition, of a single type of an ultraviolet photopolymerizable oligomer including at least two ether groups and at least two acrylate groups.

### BACKGROUND

Three-dimensional (3D) printing is an additive manufacturing process used to make three-dimensional solid parts from a digital model. 3D printing techniques are considered additive manufacturing processes because they involve the application of successive layers of material (which, in some examples, may include build material, binder and/or other printing liquid(s), or combinations thereof). This is unlike traditional machining processes, which often rely upon the removal of material to create the final part. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1-3 illustrate example 3D printing processes for making a metal green part.

FIGS. 4 and 5 illustrate example 3D printers that may be used to implement the processes shown in FIGS. 1-3.

FIGS. 6-13 present a sequence of views for printing a green part using the printer shown in FIG. 5.

FIG. 14 shows an example green part after decaking.

### DETAILED DESCRIPTION

The 3D printing techniques disclosed herein utilize a digital 3D model of the 3D object that is to be created, and this digital 3D model is sliced into multiple digital layers. The digital layers are used as the model for the selective application of an inkjet binder composition that includes a specific type of oligomer in a specific vehicle. The inkjet binder composition exhibits both inkjet stability and the ability to polymerize the oligomer in 1 second or less when exposed to a particular dosage of UV radiation.

The viscosity measurements set forth herein represent those measured by a viscometer at a particular temperature and at a particular shear rate (s⁻¹) or at a particular speed. The temperature and shear rate or temperature and speed are identified with individual values. Viscosity may be measured, for example, by a VISCOLITE™ viscometer (from Hydromotion) or another suitable instrument.

Throughout this disclosure, a weight percentage that is referred to as “wt % active” refers to the loading of an active component of a dispersion or other formulation that is present, e.g., in the inkjet binder composition. For example, a surfactant may be present in a water-based formulation (e.g., stock solution or dispersion) before being incorporated into the vehicle of the inkjet binder composition. In this example, the wt % actives of the surfactant accounts for the loading (as a weight percent) of the surfactant molecules that are present in the inkjet binder composition, and does not account for the weight of the other components (e.g., water, etc.) that are present in the stock solution or dispersion with the surfactant molecules. The term “wt %,” without the term actives, refers to the loading (in the inkjet binder composition, etc.) of a 100% active component that does not include other non-active components therein.

### Inkjet Binder Composition

The inkjet binder composition includes: a vehicle including water and an ether co-solvent; less than 30 wt % active, based on a total weight of the binder composition, of a single type of an ultraviolet photopolymerizable oligomer including at least two ether groups and at least two acrylate groups; and a free radical photoinitiator.

In some examples, the inkjet binder composition consists of: a vehicle including water, an ether co-solvent, and at least one optional additive; less than 30 wt % active, based on a total weight of the binder composition, of a single type of an ultraviolet photopolymerizable oligomer including at least two ether groups and at least two acrylate groups; and a free radical photoinitiator. In these examples, the optional additive is selected from the group consisting of a second co-solvent, a surfactant, an anti-kogation agent, an anti-microbial agent, a dispersant, a chelating agent, and combinations thereof.

The vehicle of the inkjet binder composition includes water and the ether co-solvent.

The water may be deionized water or another form of purified water. The amount of water in the inkjet binder composition ranges from about 8 wt % to about 40 wt %. In an example, the amount of water in the inkjet binder composition ranges from about 20 wt % to about 40 wt %.

The ether co-solvent is selected from the group consisting of butyl ethyl ether, diethylene glycol ethyl ether, diethylene glycol butyl ether, and combinations thereof. The total amount of the ether co-solvent(s) in the inkjet binder composition ranges from about 5 wt % active to about 60 wt % active, and depends, in part, upon the ultraviolet photopolymerizable oligomer that is used and the solubility of the ultraviolet photopolymerizable oligomer in water. In an example the total amount of the ether co-solvent ranges from about 5 wt % active to about 28 wt % active, based on the total weight of the inkjet binder composition. As described in more detail herein, the ultraviolet photopolymerizable oligomers are at least partially soluble or miscible in water and are at least partially soluble or miscible in the ether co-solvent(s).

In some examples, the ether co-solvent may be used to get the ultraviolet photopolymerizable oligomer in solution, and then a desired amount of water (e.g., in combination with other vehicle additive(s)) may be added to aid in generating an inkjettable composition. In some of these examples, the ether co-solvent makes up from about 5 wt % active to about 28 wt % active of the total weight of the inkjet binder composition. In some examples, the ether co-solvent makes up from about 5 wt % active to about 10 wt % active of the total weight of the inkjet binder composition. Also in some of these examples, the weight ratio of the ultraviolet photopolymerizable oligomer to the ether co-solvent ranges from about 5:1 to about 1.2:1.

In other examples, a water-based solvent mixture may be used to get the ultraviolet photopolymerizable oligomer in solution, and then a desired amount of the ether co-solvent may be added to generate an inkjettable composition. In some of these examples, the water-based solvent mixture does not include an additional ether solvent. In these examples, the weight ratio of the ultraviolet photopolymerizable oligomer to the ether co-solvent ranges from about 1:1.3 to about 1:2.1. In some other of these examples, the water-based solvent mixture does include an additional ether solvent. In these examples, the weight ratio of the ultraviolet photopolymerizable oligomer to the total ether co-solvents ranges from about 1:2.1 to about 1:2.5. In any of the examples including the water-based solvent mixture, the total amount of ether co-solvent(s) makes up from about 40 wt % active to about 60 wt % active of the total weight of the inkjet binder composition.

The vehicle may also include one or more additives. The additive(s) is/are selected from the group consisting of a second co-solvent, a surfactant, an anti-kogation agent, an anti-microbial agent, a dispersant, a chelating agent, and combinations thereof. In some examples, the inkjet binder composition includes each of the second co-solvent, the surfactant, the anti-kogation agent, the anti-microbial agent, the dispersant, and the chelating agent. In other examples, the inkjet binder composition includes one or more additional co-solvents without other additive(s).

The additional co-solvent(s) (i.e., those co-solvent(s) included in addition to the water and the ether co-solvent(s)) may be selected to aid in improving the jettability of the binder composition. These co-solvents may or may not be solvents of the ultraviolet photopolymerizable oligomer, and thus may or may not further enhance the solubility of the ultraviolet photopolymerizable oligomer in the vehicle. The additional co-solvent(s) may be referred to herein as the second co-solvent, the third co-solvent, etc.

The additional co-solvent(s) may be any water soluble or water miscible organic co-solvent, such as ethanol or heavier aliphatic alcohols, aromatic alcohols, diols, polyols, glycols, lactams, formamides (substituted and unsubstituted), and acetamides (substituted and unsubstituted). Examples of these co-solvents include 1,2-alcohols, 1,3-alcohols, 1,5-alcohols, 1,6-hexanediol or other diols (e.g., 1,2-propanediol, 1,5-pentanediol, 2-methyl-1,3-propanediol, etc.), glycerol, glycols (e.g., ethylene glycol, triethylene glycol, tetraethylene glycol, etc.), N-alkyl caprolactams, unsubstituted caprolactams, 2-pyrrolidone, 1-methyl-2-pyrrolidone, 1-(2-hydroxyethyl)-2-pyrrolidone, and the like.

Each additional co-solvent(s) may be present in the inkjet binder composition in an amount ranging from about 8 wt % active to about 30 wt % active. When several additional co-solvents are used, the total amount of the additional co-solvents may range from about 15 wt % active to about 20 wt % active. In one example, pentanol is used a second/additional co-solvent. In another example, pentanol and 2-pyrrolidone are used as additional (e.g., second and third) co-solvents.

Some examples of the vehicle of the inkjet binder composition include the surfactant. Suitable surfactant(s) include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di) esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, and TERGITOL™ 15-S-9 (a secondary alcohol ethoxylate). Other suitable non-ionic surfactants are available from Chemours, including the CAPSTONE® fluorosurfactants, such as CAPSTONE® FS-35 (a non-ionic fluorosurfactant). Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the inkjet binder composition may range from about 0.01 wt % active to about 3 wt % active based on the total weight of the inkjet binder composition. In an example, the total amount of surfactant(s) in the inkjet binder composition may range from about 0.5 wt % to about 2 wt % active based on the total weight of the inkjet binder composition.

Some examples of the vehicle of the inkjet binder composition include an anti-kogation agent. An anti-kogation agent may be particularly desirable when the binder composition is to be jetted using thermal inkjet printing. Kogation refers to the deposit of dried printing liquid (e.g., binder) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

When included, the anti-kogation agent may be present in the inkjet binder composition in an amount ranging from about 0.1 wt % active to about 1.5 wt % active, based on the total weight of the inkjet binder composition. In an example, the anti-kogation agent is present in an amount of about 1 wt % active, based on the total weight of the inkjet binder composition.

Some examples of the inkjet binder composition include an anti-microbial agent. Anti-microbial agents are also known as biocides and/or fungicides. Examples of suitable anti-microbial agents include the NUOSEPT® (Ashland Inc.), UCARCIDE™ or KORDEK™ or ROCIMA™ (The Dow Chemical Company), PROXEL® (Arch Chemicals) series, ACTICIDER B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of anti-microbial agent(s) in the inkjet binder composition ranges from about 0.01 wt % active to about 0.2 wt % active (based on the total weight of the inkjet binder composition). In another example, the total amount of anti-microbial agent(s) in the inkjet binder composition is about 0.1 wt % active (based on the total weight of the inkjet binder composition).

Some examples of the inkjet binder composition include a dispersant. Examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

In an example, the total amount of dispersant(s) in the inkjet binder composition ranges from about 0.01 wt % active to about 0.05 wt % active (based on the total weight of the inkjet binder composition). In another example, the total amount of dispersant(s) in the inkjet binder composition is about 0.02 wt % active (based on the total weight of the inkjet binder composition).

Some examples of the inkjet binder composition include a chelating agent. Chelating agents (or sequestering agents) may be included in the vehicle of the inkjet binder composition to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the inkjet binder composition may range from greater than 0 wt % active to about 0.5 wt % active based on the total weight of the inkjet binder composition. In an example, the chelating agent is present in an amount ranging from about 0.05 wt % active to about 0.2 wt % active based on the total weight of inkjet binder composition. In another example, the chelating agent(s) is/are present in the inkjet binder composition in an amount of about 0.08 wt % active (based on the total weight of the inkjet binder composition).

In any of the examples disclosed herein, it is to be understood that the binder composition includes a single type of ultraviolet photopolymerizable oligomer. By “single type,” it is meant that the oligomer in the composition has a particular chemical structure and is used without other oligomers of a different chemical structure and/or monomers. It is to be understood that oligomers having the same chemical structure but different molecular weights (i.e., different number of repeat units) may be used together as long as the oligomers can polymerize within one second or less as described in the methods disclosed herein. As such, combinations of different types (i.e., different chemical structures) of ultraviolet photopolymerizable oligomers are not used, and combinations of the ultraviolet photopolymerizable oligomer as disclosed herein with other monomers are not used.

The ultraviolet photopolymerizable oligomer is soluble or miscible in the combination of the water and the ether co-solvent. By “soluble,” it is meant that a solid ultraviolet photopolymerizable oligomer dissolves in the combination of the water and the ether co-solvent. By “miscible,” it is meant that a liquid ultraviolet photopolymerizable oligomer mixes in all proportions of the combination of the water and the ether co-solvent.

In some examples, the ultraviolet photopolymerizable oligomer is soluble/miscible in up to 25 wt % water and is soluble/miscible in the ether co-solvent in a weight ratio (oligomer:ether co-solvent) up to 5:1. In these examples, a higher oligomer:ether co-solvent weight ratio leads to problems with getting the oligomer into solution. While the oligomer may be soluble in the ether co-solvent at a lower oligomer:ether co-solvent weight ratio than 1.2:1, effective polymerization may not be produced. Thus, in these examples, the ultraviolet photopolymerizable oligomer is soluble/miscible in the ether co-solvent in a weight ratio (oligomer:ether co-solvent) ranging from 1.2:1 to 5:1. Some specific examples of the ultraviolet photopolymerizable oligomer with this solubility/miscibility include LAROMER® EA 8765 R (an aliphatic epoxy-modified acrylate oligomer, namely 1,4-butanediylbis(2-hydroxy-3,1-propanediyl)diacrylate, from BASF Corp.), LAROMER® PO 8982 (a polyether-modified acrylic resin from BASF Corp.), and CN 132 (1,4-butanediylbis(2-hydroxy-3,1-propanediyl)diacrylate from Sartomer (Arkema Group)). In these examples, the ether co-solvent (present at a suitable weight ratio with respect to the oligomer) may be used to get the ultraviolet photopolymerizable oligomer in solution, and then a desirable amount of water may be added as long as the solution remains clear.

In other examples, the ultraviolet photopolymerizable oligomer has a water solubility or miscibility of 1,200 mg/L at 20° C. One specific example of this ultraviolet photopolymerizable oligomer is SR 9020 (propoxylated glycerol triacrylate from Sartomer (Arkema Group). It has been found that this type of ultraviolet photopolymerizable oligomer is soluble in a water-based solvent mixture that includes a 1:1:1 weight ratio of water, 2-pyrollidone or diethylene glycol ethyl ether, and pentanol. In an example, the weight ratio of the oligomer to the water-based solvent mixture is 0.96:1. In these examples, the water-based solvent mixture (present at a suitable weight ratio with respect to the oligomer) may be used to get the ultraviolet photopolymerizable oligomer in solution, and then a desirable amount of the ether co-solvent may be added as long as the solution remains clear.

The ultraviolet photopolymerizable oligomer includes at least two ether groups and at least two acrylate groups. As an example, the ultraviolet photopolymerizable oligomer may be a polyether-modified acrylic resin. Some examples of the polyether-modified acrylic resin may be generated by reacting poly(alkylene oxide) and acrylic acid. In some instances, the poly(alkylene oxide) contains glycidyl ethers, and in these instances, the ultraviolet photopolymerizable oligomer may also be referred to as an aliphatic epoxy-modified acrylate oligomer. Examples of these ultraviolet photopolymerizable oligomers include the reaction products of butanediol diglycidyl ether (BDDGE), poly(ethylene glycol) diglycidyl ether (PEGDGE), or poly(propylene glycol) diglycidyl ether (PPGDGE) with acrylic acid, as long as the reaction products can polymerize within one second or less as described in the methods disclosed herein. The reaction product of BDDGE and acrylic acid is 1,4-butanediylbis(2-hydroxy-3,1-propanediyl)diacrylate, which is represented by the following structure:

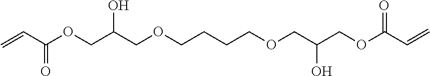 [SMILES: C=CC(=O)OCC(O)COCCCCOCC(O)COC(=O)C=C]

The reaction product of PEGDGE and acrylic acid can be represented by the following structure:

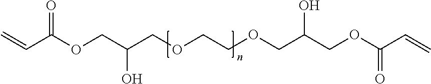

where “n” depends upon the molecular weight of the PEGDGE. Other examples of the polyether-modified acrylic resin may be generated by reacting glycerol ethoxylate or glycerol propoxylate with acrylic acid. The reaction product of glycerol propoxylate with acrylic acid is propoxylated glycerol triacrylate, which can be represented by the following structure:

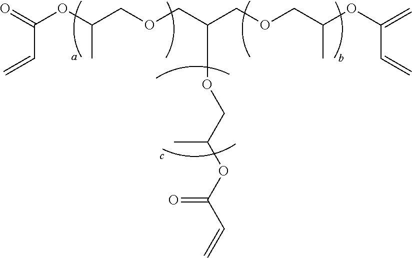

where a+b+c=an integer between 1 and 300. In some examples, a+b+c≤10. In one example, a+b+c=3. In one example, the ultraviolet photopolymerizable oligomer is selected from the group consisting of propoxylated glycerol triacrylate and 1,4-butanediylbis(2-hydroxy-3,1-propanediyl)diacrylate.

The oligomer disclosed herein includes at least 2 repeat units and undergoes polymerization to generate a polymer containing more repeat units than the oligomer. In one example, the number of repeat units in the oligomer ranges from 2 to 300, or from 2 to 150, or from 2 to 50, or from 2 to 25, or from 2-10, or any range between 2 to 300. The oligomer may also be defined by its weight average molecular weight, which may vary depending upon the number of repeat units. In one example, the weight average molecular weight of the oligomer is 750 g/mol or less, e.g., 500 g/mol, 275 g/mol, etc.

Some commercially available examples of the ultraviolet photopolymerizable oligomer include the previously mentioned LAROMER® EA 8765 R (an aliphatic epoxy-modified acrylate oligomer, namely 1,4-butanediylbis(2-hydroxy-3,1-propanediyl)diacrylate, from BASF Corp.), LAROMER® PO 8982 (a polyether-modified acrylic resin from BASF Corp.), CN 132 (1,4-butanediylbis(2-hydroxy-3,1-propanediyl)diacrylate from Sartomer (Arkema Group)), and SR 9020 (propoxylated glycerol triacrylate from Sartomer (Arkema Group)).

The ultraviolet photopolymerizable oligomer is capable of undergoing free radical polymerization in the presence of the photoinitiator and when exposed to UV radiation (at 380 nm or less) from a Xenon flash lamp for less than 1 second (e.g., from about 10 ms to about 100 ms).

The ultraviolet photopolymerizable oligomer is present in an amount of less than 30 wt % active, based on a total weight of the binder composition. Higher amounts of the ultraviolet photopolymerizable oligomer may render the composition non-jettable via a thermal inkjet printhead. In one example, the ultraviolet photopolymerizable oligomer is present in an amount ranging from about 15 wt % active to about 24 wt % active, based on the total weight of the binder composition. Lower amounts of the ultraviolet photopolymerizable oligomer may be used, as long as the polymerization is not deleteriously affect (e.g., as evidenced by a green part that cannot be lifted without breaking).

The ultraviolet photopolymerizable oligomer is also capable of decomposing into volatile by-products when heated at elevated temperatures (e.g., 400° C. or higher). Thus, the ultraviolet photopolymerizable oligomer leaves little to no residue in the final 3D printed object. Little residue means that from about 0.001% to about 0.1% of the total solids in the final 3D object is the polymer generated from the ultraviolet photopolymerizable oligomer.

Any free radical photoinitiator may be included in the inkjet binder composition. The free radical photoinitiator generates free radicals when exposed to the UV radiation disclosed herein, which react with the oligomer to grow polymer chain(s). Examples of suitable free radical photoinitiators include phosphine oxide initiators, such as diphenyl(2,4,6-trimethylbenzoyl) phosphine oxide (DPPO) and phenylbis(2,4,6-trimethylbenzoyl) phosphine oxide (PBPO). Another suitable photoinitiator is 2-hydroxy-4′-(2-hydroxyethoxy)-2-methylpropiophenone.

The free radical photoinitiator is present in an amount ranging from about 0.1 wt % active to about 3 wt % active, based on the total weight of the inkjet binder composition. In an example, the free radical photoinitiator is present in an amount of about 0.8 wt % active, based on the total weight of the inkjet binder composition. The amount of the free radical initiator may also be based on the amount of the ultraviolet photopolymerizable oligomer in the inkjet binder composition. For example, the amount of the free radical initiator may range from about 0.3 wt % to about 5 wt % based on the amount of the ultraviolet photopolymerizable oligomer in the inkjet binder composition. In one specific example, the amount of the initiator is about 4% of the total amount of the ultraviolet photopolymerizable oligomer.

In some examples, the inkjet binder composition has a viscosity suitable for thermal inkjet printing. In an example, the inkjet binder composition has a viscosity ranging from about 0.5 cP to about 10 cP at a temperature ranging from about 20° C. to about 25° C. and a shear rate of about 3,000 Hz). In another example, the inkjet binder composition has a viscosity ranging from about 0.8 cP to about 5 cP at a temperature ranging from about 20° C. to about 25° C. and a shear rate of about 3,000 Hz). If the inkjet binder composition is to be printed via piezoelectric inkjet printing, the viscosity may range from about 0.5 cP to about 25 cP at a temperature ranging from about 20° C. to about 25° C. and a shear rate of about 3,000 Hz).

### Method for Making the Inkjet Binder Composition

In a first example of the method to generate one example of the inkjet binder composition, the ultraviolet photopolymerizable oligomer may be dissolved in the ether co-solvent to form a solution, and then the photoinitiator and the remaining vehicle components may be mixed with the solution. In one specific example of this first method, the remaining vehicle components include the water, the second co-solvent, the surfactant, the anti-kogation agent, the anti-microbial agent, the dispersant, and the chelating agent. In this example, the weight ratio of the ultraviolet photopolymerizable oligomer to the ether co-solvent ranges from about 5:1 to about 1.2:1, and the ether co-solvent makes up from about 5 wt % active to about 10 wt % active of the total weight of the inkjet binder composition. Any of the vehicle component(s) may be included in the amounts disclosed herein. When the vehicle amount is 55 wt % or more, the weight ratio of the ultraviolet photopolymerizable oligomer to the ether co-solvent ranges from about 5:1 to about 1.3:1.

This first example method may be particularly suitable for the LAROMER® and CN 132 photopolymerizable oligomers.

In a second example of the method to generate another example of the inkjet binder composition, the ultraviolet photopolymerizable oligomer may be dissolved in the water-based solvent mixture to form a solution, and then the photoinitiator and the ether co-solvent may be mixed with the solution. The other vehicle additive(s) may or may not be included.

In some examples of this second method, the water-based solvent mixture does not include an additional ether solvent. An example of this water-based solvent mixture includes water, 2-pyrollidone, and pentanol. In one example, the weight ratio of the water, 2-pyrollidone, and pentanol is 1:1:1, and the weight ratio of the water-based solvent mixture to the ultraviolet photopolymerizable oligomer is about 1:1 to about 1.1:1. The ultraviolet photopolymerizable oligomer is added to the water-based solvent mixture and stirred to achieve dissolution or miscibility. The oligomer containing solvent mixture may then be mixed with the photoinitiator and the ether co-solvent to form the inkjet binder composition. In these examples, the weight ratio of the ultraviolet photopolymerizable oligomer to the ether co-solvent ranges from about 1:1.3 to about 1:2.1, and the ether co-solvent makes up from about 40 wt % active to about 50 wt % active of the total weight of the inkjet binder composition.

In other examples of this second method, the water-based solvent mixture does include an additional ether solvent. An example of this water-based solvent mixture includes water, diethylene glycol ethyl ether, and pentanol. In one example, the weight ratio of the water, diethylene glycol ethyl ether, and pentanol is 1:1:1, and the weight ratio of the water-based solvent mixture to the ultraviolet photopolymerizable oligomer is about 1:1 to about 1.1:1. The ultraviolet photopolymerizable oligomer is added to the water-based solvent mixture and stirred to achieve dissolution or miscibility. The oligomer containing solvent mixture may then be mixed with the photoinitiator and the other ether co-solvent to form the inkjet binder composition. In these examples, the weight ratio of the ultraviolet photopolymerizable oligomer to the total amount of ether co-solvents ranges from about 1:2.1 to about 1:2.5, and the ether co-solvent makes up from about 50 wt % active to about 60 wt % active of the total weight of the inkjet binder composition.

Any example of the second method may be particularly suitable for the SR 9020 photopolymerizable oligomers.

### Metal Build Material Composition

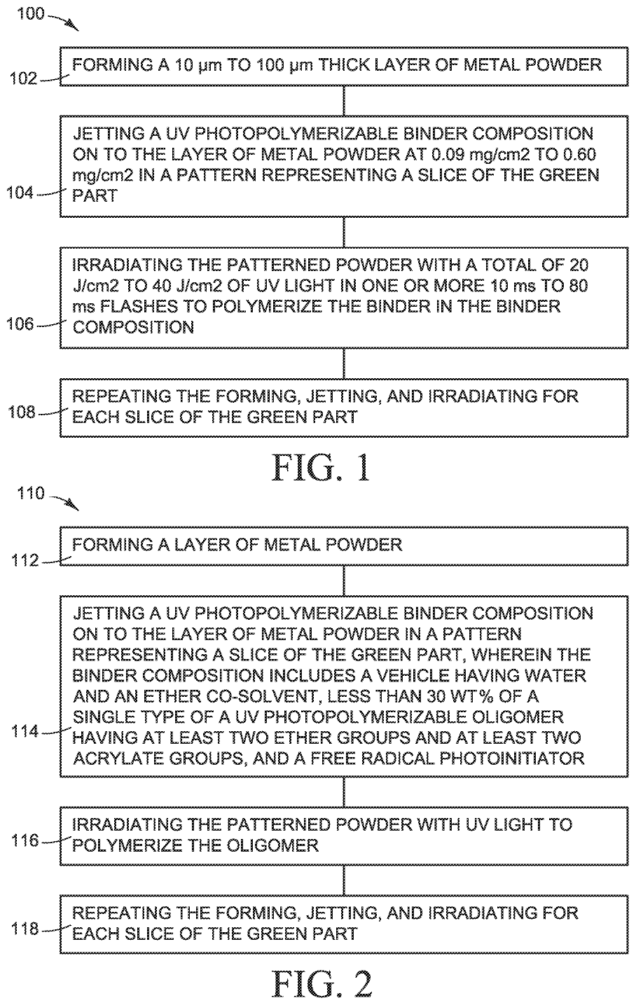

Any suitable metal powder commonly used for 3D printing may be used with the binder composition disclosed herein and in the processes shown in FIG. 1 through FIG. 3. As noted above, a “metal powder” as used herein means particulate matter composed primarily of metal particles, usually at least 80 wt % metal particles. Metal powders used for 3D printing metal green parts may (and often do) include flow aids and/or other additives. Any suitable metal powder may be used that the polymerized binder can wet and physically adhere to. Some examples of suitable metal powders include aluminum, titanium, molybdenum, tungsten, copper, cobalt, chromium, nickel, vanadium, tungsten carbide, tantalum, magnesium, gold, silver, iron, stainless-steel, steel, alloys thereof, or admixtures thereof.

The average particle size of the metal-based particles can be similarly sized or differently sized. In one example, the average particle size of the metal-based particles can range from 0.5 μm to 200 μm. In some examples, the metal-based particles within a distribution can have a median diameter (D50) ranging from about 2 μm to about 150 μm, from about 1 μm to about 100 μm, from about 1 μm to about 50 μm, etc.

The shape of the metal-based particles can be spherical, non-spherical, random shapes, or a combination thereof.

### Printing Method

In one example of the new process, a UV photopolymerizable binder composition (i.e., the inkjet binder composition disclosed herein) is jetted on to a 10 μm to 100 μm thick layer of metal powder at 0.09 mg/cm² to 0.60 mg/cm² in a pattern representing a slice of the green part, and then irradiated with a total of 20 J/cm² to 40 J/cm² of UV light in one or more 10 ms to 80 ms flashes to polymerize an oligomer binder in the binder composition. The process is repeated for each slice of the green part. As described in more detail below, the polymerized binder may begin to decompose if too much energy is applied and/or applied too slowly, while polymerization may be incomplete and the binder remain gooey if too little energy is applied. If too much binder composition is jetted on to the metal powder, polymerization may be incomplete and/or excess polymer will be present during sintering. If too little binder composition is jetted on to the metal powder, the polymerized binder may begin to decompose during irradiation and/or the polymerized binder may be too sparse, resulting in a weaker green part.

These and other examples of the new process are not necessarily limited to use with the new binder composition, but could be used with other UV photopolymerizable binder compositions for printing metal green parts, including UV photopolymerizable binder compositions that might be developed in the future. The examples shown in the figures and described herein illustrate but do not limit the scope of the patent, which is defined in the Claims following this Description.

As used in this document: “and/or” means one or more of the connected things; a “photopolymerizable binder composition” means a photopolymerizable oligomer and a vehicle that carries the oligomer—the oligomer in the composition is sometimes referred to herein as a “binder”; a “computer readable medium” means any non-transitory tangible medium that can embody, contain, store, or maintain programming for use by a computer processor and may include, for example, circuits, integrated circuits, ASICs, hard drives, random access memory (RAM), and read-only memory (ROM); a “metal green part” means a coherent but unfused structure of bound metal powder that may be sintered to fuse the powder and burn off the binder to form an object; and a “metal powder” means particulate matter composed primarily of metal particles.

FIG. 1 illustrates an example 3D printing process 100 for making a metal green part. Referring to FIG. 1, process 100 includes forming a 10 μm to 100 μm thick layer of metal powder (block 102), jetting a UV photopolymerizable binder composition on to the layer of metal powder at 0.09 mg/cm² to 0.60 mg/cm² in a pattern representing a slice of the green part (block 104), irradiating the patterned powder with a total of 20 J/cm² to 40 J/cm² of UV light in one or more 10 ms to 80 ms flashes to polymerize the binder in the binder composition (block 106), and repeating the forming, jetting, and irradiating for each slice of the green (block 108).

FIG. 2 illustrates another example 3D printing process 110 for making a metal green part. Referring to FIG. 2, process 110 includes forming a layer of metal powder (block 112), jetting a UV photopolymerizable binder composition on to the layer of metal powder in a pattern representing a slice of the green part, wherein the binder composition includes a vehicle having water and an ether co-solvent, less than 30 wt % of a single type of a UV photopolymerizable oligomer having at least two ether groups and at least two acrylate groups, and a free radical photoinitiator (block 114), irradiating the patterned powder with UV light to polymerize the oligomer (block 116); and repeating the forming, jetting, and irradiating for each slice of the green part (block 118).

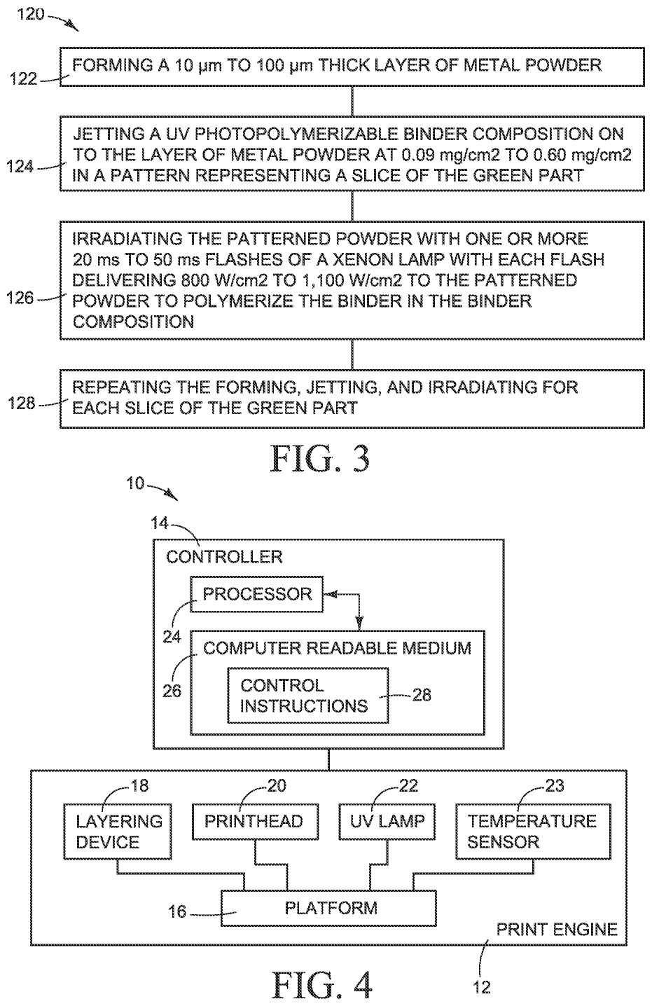

FIG. 3 illustrates another example 3D printing process 120 for making a metal green part. Referring to FIG. 3, process 120 includes forming a 10 μm to 100 μm thick layer of metal powder (block 122), jetting a UV photopolymerizable binder composition on to the layer of metal powder at 0.09 mg/cm² to 0.60 mg/cm² in a pattern representing a slice of the green part (block 124), irradiating the patterned powder with one or more 20 ms to 50 ms flashes of a Xenon lamp with each flash delivering 800 W/cm² to 1,100 W/cm² to the patterned powder to polymerize the binder in the binder composition (block 126), and repeating the forming, jetting, and irradiating for each slice of the green part (block 128).

Short flashes of light limit the radiation absorbed by the metal powder and thus the heat transferred from the metal powder to the surrounding binder, to reduce the risk of overheating the binder. An oligomer binder, for example, may start to decompose if heated above 150° C. Testing suggests that the values in FIGS. 1 and 3 should be adequate under many printing conditions to prevent an oligomer binder from reaching 150° C. during irradiation. Testing also suggests metal powder layers thicker than 100 μm may inhibit the binder composition and/or the UV light from fully penetrating each layer, resulting in poor binding and weaker green parts. The combination of values in FIGS. 1-3 reflect a balance among the various process parameters that helps ensure rapid polymerization with good binding for strong green parts and with near total removal of the polymerized binder during sintering.

FIG. 4 is a block diagram illustrating one example of a 3D printer 10 that may be used to implement the processes shown in FIGS. 1-3. Referring to FIG. 4, printer 10 includes a print engine 12 and a controller 14. In this example, print engine 12 includes a platform 16 to support a metal powder during printing, a layering device 18 to layer metal powder on to platform 16, an inkjet printhead 20 to selectively jet a liquid binder composition on to metal powder on platform 16, a UV lamp 22 to irradiate metal powder on platform 16, and a temperature sensor 23 to sense the temperature of patterned powder on platform 16.

Platform 16 may be implemented, for example, as a fixed component in print engine 12 or a portable component moved into printer 10 for printing and out of printer 10, for example to a decaking station after printing. Layering device 18 may be implemented, for example, as a blade, a roller, and/or a dispenser that moves back and forth over platform 16. Inkjet printhead 20 may be implemented, for example, as a thermal inkjet printhead or a piezo inkjet printhead. Inkjet printhead 20 usually will be implemented, for example, in a printhead assembly with multiple printheads including, for example, a print bar spanning the width of platform 16. Although not shown in FIG. 4, print engine 12 may include a single carriage or multiple carriages to carry layering device 18, printhead 20, and/or UV lamp 22 over platform 16.

Controller 14 includes the programming, processing and associated memory resources, and the other electronic circuitry and components to control the operative elements of printer 10, including print engine 12. Controller 14 in FIG. 4 includes a processor 24 and a computer readable medium 26 with control instructions 28 operatively connected to processor 24. Controller 14 may include distinct control elements for individual systems and components of printer 10, including print engine 12. Although print engine 12 and controller 14 are shown in different blocks in FIG. 1, some of the control elements of controller 14 may reside within print engine 12, for example close to the print engine components they control.

In one example, computer readable medium 26 includes control instructions 28 that, when executed, cause printer 10 to perform the process 100 shown in FIG. 1. In another example, computer readable medium 26 includes control instructions 28 that, when executed, cause printer 10 to perform the process 110 shown in FIG. 2. In another example, computer readable medium 26 includes control instructions 28 that, when executed, cause printer 10 to perform the process 120 shown in FIG. 3. In some examples, control instructions 28 include instructions to not raise the temperature of the patterned powder to more than 150° C. while lamp 22 is irradiating the patterned powder, based on signals from temperature sensor 23.

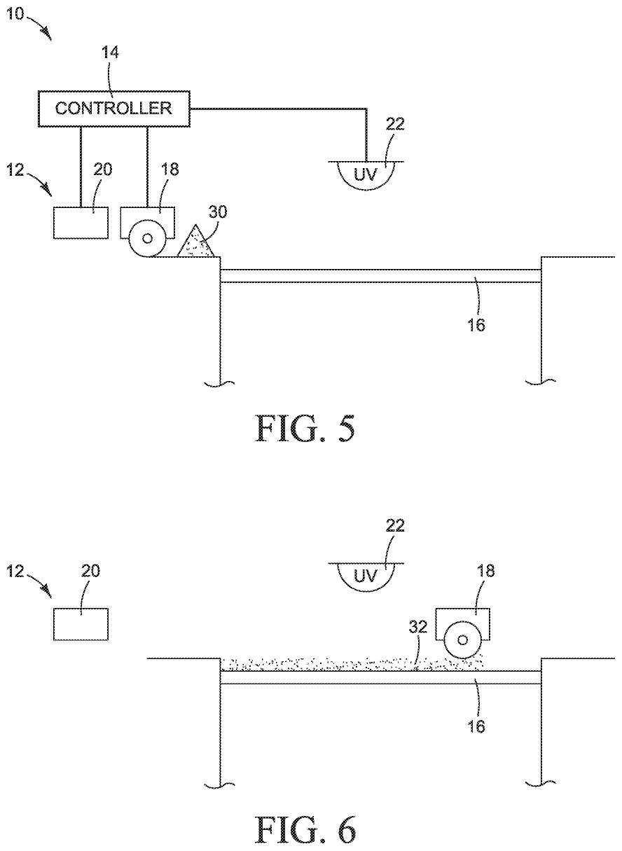

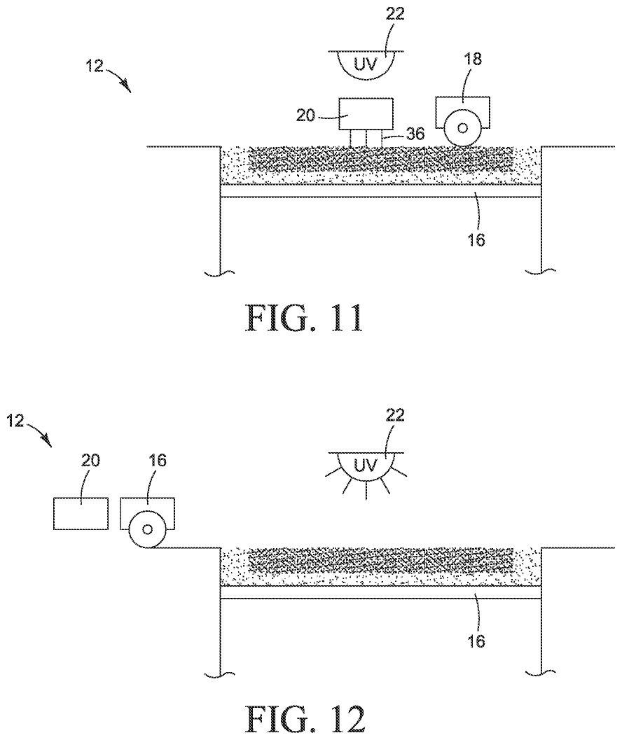

FIG. 5 illustrates an example 3D printer 10 such as might be used to implement the processes shown in FIGS. 1-3. Referring to FIG. 5, printer 10 includes a print engine 12 and a controller 14 such as the example controller 14 shown in FIG. 4. FIGS. 6-13 present a sequence of views for printing a green part using the printer 10 shown in FIG. 5. Controller 14 is omitted from FIGS. 6-11. Referring to FIGS. 5-13, print engine 12 includes a platform 16, a layering device 18, an inkjet printhead 20, and a UV lamp 22. In this example, layering device 18 is implemented as a roller. A pile of metal powder 30 is staged next to platform 12 in FIG. 5 in preparation for the next layer of metal powder. Roller 18 and printhead 20 are moved back and forth over platform 12 at the direction of controller 14. Roller 18 and printhead 20 may be carried together on the same carriage or separately on separate carriages. Roller 18 and printhead 20 may move back and forth along the same axis, as shown, or along orthogonal or otherwise different axes.

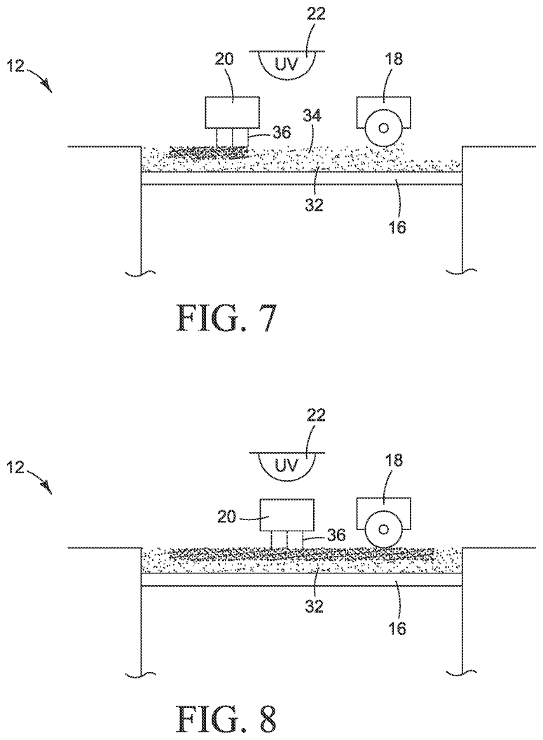

In FIG. 6, UV lamp 22 is off and roller 18 is moving to the right spreading metal powder over platform 16 in a first layer 32. In FIG. 7, UV lamp 22 is off and roller 18 is moving to the right spreading a second layer 34 of metal powder followed by printhead 20 jetting a UV photopolymerizable binder composition 36 on to powder in layer 34 in a pattern corresponding to a slice of the green part. In this example, binder composition 36 is jetted in the desired amount in two passes of printhead 20 over layer 34. Printhead 20 is moving to the right in FIG. 7 in a first pass jetting binder composition 36 in the desired pattern. Printhead 20 is moving to the left in FIG. 8 back over layer 34 in a second pass jetting binder composition 36 in the desired pattern. The desired volume of binder composition 36 may be jetted in one or multiple passes. Two passes is just one example. While a single pass is faster, multiple passes may be desirable, for example, to reduce powder disturbance and/or improve dimensional accuracy.

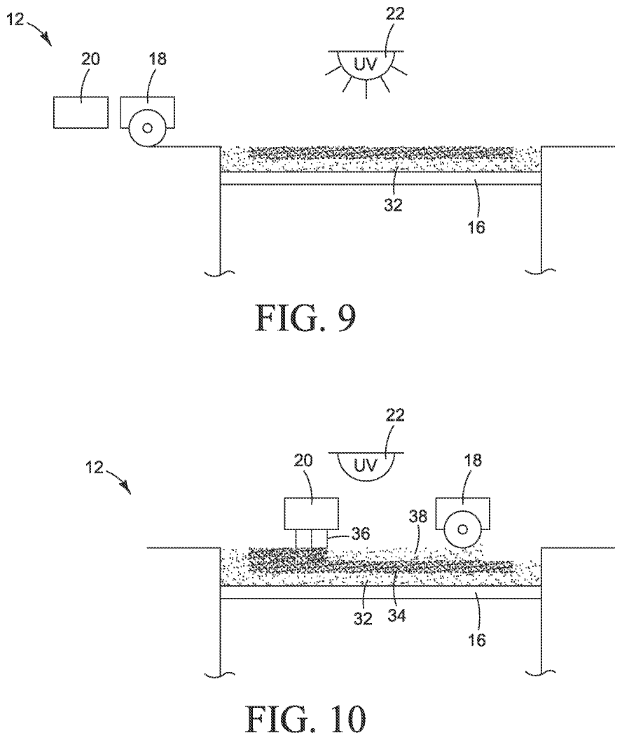

In FIG. 9, UV lamp 22 is on, irradiating the patterned powder to polymerize the binder in the binder composition and bind together the metal powder into one slice of the green part, for example as described above with reference to FIGS. 1-3. Although an overhead UV lamp 22 is shown in FIGS. 5-11, a carriage mounted lamp that moves back and forth over platform 16 could be used.

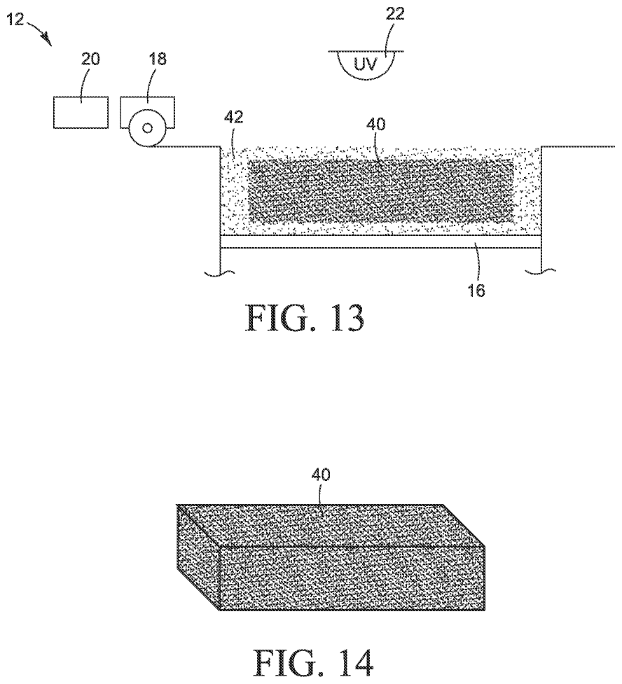

The process of layering, jetting, and irradiating is repeated for the next layer 38 as shown in FIGS. 10-12 and for multiple successive layers until the green part is complete. FIG. 13 shows a green part 40 before removal from the powder bed 42. FIG. 14 shows green part 40 after decaking. A simple part 40 with only a few layers are shown and the thickness of each layer is greatly exaggerated in FIGS. 6-13. Complex parts with hundreds or thousands of very thin layers are common in 3D printing metal green parts.

To further illustrate the present disclosure, an example is given herein. It is to be understood that this example is provided for illustrative purposes and is not to be construed as limiting the scope of the present disclosure.

### Example

To arrive at the inkjet binder compositions as described herein, several potential compositions were prepared and tested.

For the test compositions, LAROMER® EA 8765 R or LAROMER® PO 8982 or SR 9020 were utilized as the UV photopolymerizable oligomer.

The respective LAROMER® oligomers were dissolved in an ether solvent (i.e., butyl ethyl ether or diethylene glycol ether) at the weight ratios set forth in Table 1 and were assessed for clarity (e.g., cloudiness), as this is an indication of incomplete dissolution/miscibility. As shown in Table 1, different weight ratios of the LAROMER® oligomers and ether solvent were tested.

The clear LAROMER®:ether solvent solutions were mixed with different weight percentages of a vehicle including: about 40 wt % active of an additional co-solvent (e.g., 2-pyrrolidone), about 1 wt % active of an anti-kogation agent, about 1.6 wt % active of non-ionic surfactant(s), 0.02 wt % active of a dispersant, 0.08 wt % active of a chelating agent, about 0.13 wt % active of anti-microbial(s), and a balance of water (about 57.17 wt %); and a photoinitiator (either diphenyl(2,4,6-trimethylbenzoyl) phosphine oxide (DPPO) or phenylbis(2,4,6-trimethylbenzoyl) phosphine oxide (PBPO)).

The SR 9020 oligomer was dissolved in a water based solvent mixture of 1:1:1 water:2 pyrrolidone:pentanol or 1:1:1 water:diethylene glycol ethyl ether:pentanol, and the respective solutions were assessed for clarity (e.g., cloudiness). Different weight percentages were tested and are set forth in Table 2. The clear SR 9020:water based solvent mixture solutions were mixed with different weight percentages of diethylene glycol butyl ether and a photoinitiator (2-hydroxy-4′-(2-hydroxyethoxy)-2-methylpropiophenone).

Printing of the various compositions via thermal inkjet pens was tested. A first test print was generated for each of the compositions, and then the pens were allowed to sit idle for several days. A second test print was attempted for each composition.

The compositions that generated successful first and second test prints were deemed stable and were thermal inkjet printed onto respective layers of stainless steel build material having a thickness of about 100 μm. The layers were exposed to ultraviolet radiation at 365 nm using a Xenon flash lamp. Exposure was less than 1 second long, and then the polymerization was evaluated. Polymerization was deemed good if the metal coupon fused with the solidified polymer could be lifted off of the build platform without breaking. Polymerization was deemed poor if the metal coupon broke when lifted.

Table 1 depicts the LAROMER® compositions and results. More particularly, the wt % of the vehicle, the LAROMER®:ether solvent weight ratio, the wt % of the LAROMER® oligomer in the composition, the weight percentage of the ether solvent, the weight percentage of the photoinitiator, and the print and polymerization results are shown in Table 1. In Table 1, [1]=LAROMER® EA 8765R, [2]=LAROMER® PO 8982, Y=printed and polymerized, NP=did not print, PNP=printed but poor polymerization, NT=not tested, (?)=unclear results (questionable whether polymerization was good.)

TABLE 1

| | Oligomer:ether | | Wt % of | | Print and |
|---|---|---|---|---|---|
| Vehicle | solvent weight | Wt % of | ether | Wt % of | Polymerization |
| wt % | ratio | oligomer | solvent | photoiniator | results |
| 65 | ~5:1 | 29 | 5.2 | 0.8 | [1] = NT |
| | | | | | [2] = Y |
| | ~4:1 | 28 | 6.2 | 0.8 | [1] = Y |
| | | | | | [2] = Y |
| | ~3:1 | 26.25 | 7.95 | 0.8 | [1] = Y |
| | | | | | [2] = NT |
| | ~2:1 | 23.33 | 10.87 | 0.8 | [1] = Y |
| | | | | | [2] = Y |
| | ~1.75:1 | 22.27 | 11.93 | 0.8 | [1] = NT |
| | | | | | [2] = Y |
| | ~1.5:1 | 21 | 13.2 | 0.8 | [1] = Y (?) |
| | | | | | [2] = Y (?) |
| | ~1.3:1 | 19.78 | 14.42 | 0.8 | [1] = NT |
| | | | | | [2] = Y |
| | ~1.2:1 | 19.09 | 15.11 | 0.8 | [1] = PNP |
| | | | | | [2] = Y |
| 60 | ~5:1 | 33.3 | 5.9 | 0.8 | [1] = NP |
| | | | | | [2] = NP |
| | ~4:1 | 32 | 7.2 | 0.8 | [1] = NT |
| | | | | | [2] = Y |
| | ~2.5:1 | 28.57 | 10.63 | 0.8 | [1] = Y |
| | | | | | [2] = Y |
| | ~2:1 | 26.66 | 12.54 | 0.8 | [1] = Y |
| | | | | | [2] = Y |
| | ~1.5:1 | 24 | 15.2 | 0.8 | [1] = Y |
| | | | | | [2] = Y |
| | ~1.3:1 | 22.6 | 16.6 | 0.8 | [1] = PNP |
| | | | | | [2] = Y (?) |
| | ~1.2:1 | 21.81 | 17.39 | 0.8 | [1] = PNP (?) |
| | | | | | [2] = Y |
| 55 | ~5:1 | 37.5 | 6.7 | 0.8 | [1] = NP |
| | | | | | [2] = NP |
| | ~4:1 | 36 | 8.2 | 0.8 | [1] = NT |
| | | | | | [2] = Y |
| | ~3:1 | 33.75 | 10.45 | 0.8 | [1] = NT |
| | | | | | [2] = Y |
| | ~2.5:1 | 32.14 | 12.06 | 0.8 | [1] = Y |
| | | | | | [2] = Y |
| | ~2:1 | 30 | 14.2 | 0.8 | [1] = Y |
| | | | | | [2] = Y |
| | ~1.75:1 | 28.64 | 15.56 | 0.8 | [1] = Y |
| | | | | | [2] = Y |
| | ~1.5:1 | 27 | 17.2 | 0.8 | [1] = Y |
| | | | | | [2] = Y |
| | ~1.3:1 | 25.43 | 18.77 | 0.8 | [1] = PNP |
| | | | | | [2] = Y |
| | ~1.2:1 | 24.54 | 19.66 | 0.8 | [1] = PNP |
| | | | | | [2] = PNP (?) |
| 50 | ~5:1 | 41.66 | 7.54 | 0.8 | [1] = NP |
| | | | | | [2] = NP |
| | ~4:1 | 40 | 9.2 | 0.8 | [1] = NT |
| | | | | | [2] = Y |
| | ~3:1 | 37.5 | 11.7 | 0.8 | [1] = NT |
| | | | | | [2] = NP |
| | ~2.5:1 | 35.71 | 13.49 | 0.8 | [1] = Y |
| | | | | | [2] = Y |
| | ~1.75:1 | 31.82 | 17.38 | 0.8 | [1] = Y |
| | | | | | [2] = NT |
| | ~1.5:1 | 30 | 19.2 | 0.8 | [1] = Y |
| | | | | | [2] = Y |
| | ~1.2:1 | 27.27 | 21.93 | 0.8 | [1] = Y |
| | | | | | [2] = Y |
| 45 | ~5:1 | 45.83 | 8.37 | 0.8 | [1] = NP |
| | | | | | [2] = NP |
| | ~3:1 | 41.25 | 12.95 | 0.8 | [1] = NP |
| | | | | | [2] = NP |
| | ~2.5:1 | 39.29 | 14.91 | 0.8 | [1] = Y |
| | | | | | [2] = Y |
| | ~2:1 | 36.67 | 17.53 | 0.8 | [1] = NT |
| | | | | | [2] = Y |
| | ~1.5:1 | 33 | 21.2 | 0.8 | [1] = Y |
| | | | | | [2] = Y |
| | ~1.3:1 | 31.09 | 23.11 | 0.8 | [1] = NT |
| | | | | | [2] = Y |
| | ~1.2:1 | 30 | 24.2 | 0.8 | [1] = Y |
| | | | | | [2] = Y |
| 40 | ~5:1 | 50 | 9.2 | 0.8 | [1] = NP |
| | | | | | [2] = NP |
| | ~4:1 | 48 | 11.2 | 0.8 | [1] = NP |
| | | | | | [2] = NP |
| | ~3:1 | 45 | 14.2 | 0.8 | [1] = NP |
| | | | | | [2] = NP |
| | ~2:1 | 40 | 19.2 | 0.8 | [1] = NP |
| | | | | | [2] = NP |
| | ~1.75:1 | 38.18 | 21.02 | 0.8 | [1] = Y |
| | | | | | [2] = Y |
| | ~1.5:1 | 36 | 23.2 | 0.8 | [1] = Y |
| | | | | | [2] = Y |
| | ~1.3:1 | 33.91 | 25.29 | 0.8 | [1] = NT |
| | | | | | [2] = Y |
| | ~1.2:1 | 32.72 | 26.48 | 0.8 | [1] = Y |
| | | | | | [2] = Y |

While some of the LAROMER® compositions having more than 30 wt % of the oligomer were stable and underwent desirable polymerization, at each of the vehicle weight percentages, the printability results were inconsistent when the oligomer amount was 30 wt % or higher. In contrast, the compositions with less than 30 wt % of the oligomer were stable and polymerizable at a range of oligomer:ether solvent weight ratios and at a variety of vehicle amounts. Moreover, at lower vehicle percentages (e.g., 40 wt % and 45 wt %), it is believed that stable and polymerizable compositions can be achieved when the oligomer is present in amounts ranging from about 15 wt % to about 29 wt %.

Table 2 depicts the SR 9020 compositions and results. More particularly, the type and the wt % of the water based solvent mixture, the wt % of the SR 9020 oligomer, the weight percentage of the ether solvent, and the print and polymerization results are shown in Table 2. In Table 2, H2O=water, 2P=2 pyrrolidone, POH=pentanol, DEGEE=diethylene glycol ethyl ether, Y=printed and polymerized.

TABLE 2

| | | | | Print and |
|---|---|---|---|---|
| 1:1:1 Water | | Wt % of | | Polymer- |
| based solvent | Wt % of | ether | Wt % of | ization |
| mixture and Wt % | oligomer | solvent | photoiniator | results |
| H2O:2P:POH 25 | 24 | 50 | 1 | Y |
| H2O:DEGEE:POH 25 | 24 | 50 | 1 | Y |
| H2O:2P:POH 30 | 29 | 40 | 1 | Y |
| H2O:DEGEE:POH 30 | 29 | 40 | 1 | Y |

Each of SR 9020 compositions was stable and underwent desirable polymerization.

It is to be understood that the ranges provided herein include the stated range and any value or sub-range within the stated range, as if such values or sub-ranges were explicitly recited. For example, from about 15 wt % active to about 24 wt % active should be interpreted to include not only the explicitly recited limits of from about 15 wt % active to about 24 wt % active, but also to include individual values, such as about 18.5 wt % active, about 22.9 wt % active, about 20 wt % active, etc., and sub-ranges, such as from about 15 wt % active to about 20 wt % active, from about 17 wt % active to about 23 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet binder composition, comprising:
a vehicle including water and an ether co-solvent;
less than 30 wt %, based on a total weight of the binder composition, of a single type of an ultraviolet photopolymerizable oligomer including at least two ether groups and at least two acrylate groups; and
a free radical photoinitiator.

2. The inkjet binder composition as defined in claim 1, wherein the ultraviolet photopolymerizable oligomer is present in an amount ranging from about 15 wt % active to about 24 wt % active, based on the total weight of the binder composition.

3. The inkjet binder composition as defined in claim 1, wherein the ultraviolet photopolymerizable oligomer is selected from the group consisting of propoxylated glycerol triacrylate and 1,4-butanediylbis(2-hydroxy-3,1-propanediyl)diacrylate.

4. The inkjet binder composition as defined in claim 1, wherein the ether solvent is selected from the group consisting of butyl ethyl ether, diethylene glycol ethyl ether, diethylene glycol butyl ether, and combinations thereof.

5. The inkjet binder composition as defined in claim 4, wherein the vehicle further includes a second co-solvent, a surfactant, an anti-kogation agent, an anti-microbial agent, a dispersant, and a chelating agent.

6. The inkjet binder composition as defined in claim 5, wherein the ether co-solvent makes up from about 5 wt % active to about 10 wt % active of the total weight of the inkjet binder composition.

7. The inkjet binder composition as defined in claim 4, wherein the vehicle further includes at least one additional co-solvent selected from the group consisting of 2-pyrollidone, pentanol, and combinations thereof.

8. The inkjet binder composition as defined in claim 7, wherein the ether co-solvent makes up from about 40 wt % active to about 60 wt % active of the total weight of the inkjet binder composition.

9. The inkjet binder composition as defined in claim 1, wherein the ultraviolet photopolymerizable oligomer is soluble or miscible in a combination of the water and the ether co-solvent.

10. An inkjet binder composition, consisting of:
a vehicle including water, an ether co-solvent, and at least one optional additive;
less than 30 wt % active, based on a total weight of the binder composition, of a single type of an ultraviolet photopolymerizable oligomer including at least two ether groups and at least two acrylate groups; and
a free radical photoinitiator.

11. The inkjet binder composition as defined in claim 9, wherein:
the ultraviolet photopolymerizable oligomer is selected from the group consisting of propoxylated glycerol triacrylate and 1,4-butanediylbis(2-hydroxy-3,1-propanediyl)diacrylate; and
the ether solvent is selected from the group consisting of butyl ethyl ether, diethylene glycol ethyl ether, diethylene glycol butyl ether, and combinations thereof.

12. The inkjet binder composition as defined in claim 11, wherein:
the vehicle further includes a second co-solvent, a surfactant, an anti-kogation agent, an anti-microbial agent, a dispersant, and a chelating agent; and
the ether co-solvent makes up from about 5 wt % active to about 10 wt % active of the total weight of the inkjet binder composition.

13. The inkjet binder composition as defined in claim 11, wherein:
the vehicle further includes at least one additional co-solvent selected from the group consisting of 2-pyrollidone, pentanol, and combinations thereof; and
the ether co-solvent makes up from about 40 wt % active to about 60 wt % active of the total weight of the inkjet binder composition.

14. The inkjet binder composition as defined in claim 13, wherein the water, the 2-pyrollidone, and the pentanol are present in a weight ratio of 1:1:1.

15. A metal green part, comprising:
metal particles; and
a polymer network binding the metal particles together, the polymer network including polymerized 1,4-butanediylbis(2-hydroxy-3,1-propanediyl)diacrylate or polymerized propoxylated glycerol triacrylate.
